(19) United States
(12) Patent Application Publication
(10) Pub. No.: US 2024/0227323 A1
(43) Pub. Date: Jul. 11, 2024

(54) Methods of Making a Composite Open Lattice

(71) Applicant: Brigand Arms LLC, Birmingham, AL (US)

(72) Inventor: Austin Russell Gurley, Homewood, AL (US)

(21) Appl. No.: 18/094,594

(22) Filed: Jan. 9, 2023

(51) Int. Cl. B29C 70/32; B29C 61/02

(52) U.S. Cl. CPC B29C 70/32; B29C 61/025; B29K 2105/0881

(57) ABSTRACT

Methods and systems of making a composite open lattice are provided. The method comprises the following: (i) providing a mandrel having a plurality of studs extending outwardly from an outer surface of the mandrel, wherein the plurality of studs define a network of pathways; (ii) winding a pre-impregnated tow of structural fibers through the network of pathways and forming at least one axial lattice element (ALE), at least one helical lattice element (HLE), and a plurality of intersection locations defined by overlapping portions of the pre-impregnated tow to form an intermediate composite open lattice; and (iii) curing the intermediate composite open lattice to provide the composite open lattice. Composite open lattices are also provided.

### TECHNICAL FIELD

Embodiments of the presently-disclosed invention relate generally to methods and systems of making a composite open lattice as well as the resulting composite open lattices.

### BACKGROUND

The pursuit of structurally efficient structures having high strength to weight ratio and/or a high stiffness to weight ratio is an ongoing endeavor in a variety of fields. Accordingly, there has been interest in forming structures from composite materials to reduce weight and increase strength. In some instances, the use of continuous fibers to form an open lattice may be desired in an effort to achieve improved stiffness, strength or load bearing capacity per unit weight.

The fabrication of open lattices, however, has proven to be very difficult. Wide-spread application of such structures has been frustrated by the inability to quickly, easily, and/or inexpensively manufacture such a structure. Open lattices, for example, may require complex geometries or configurations that are burdensome to achieve with conventional manufacturing techniques.

Therefore, there remains a need in the art for improved methods and systems that can efficiently produce open lattices (e.g., three-dimensional open lattices).

### SUMMARY OF INVENTION

One or more embodiments of the invention may address one or more of the aforementioned problems. Certain embodiments according to the invention provide a method of making a composite open lattice, in which the method may comprise the following: (i) providing a mandrel having a plurality of studs extending outwardly from an outer surface of the mandrel, wherein the plurality of studs define a network of pathways; (ii) winding a pre-impregnated tow of structural fibers through the network of pathways and forming at least one axial lattice element (ALE), at least one helical lattice element (HLE), and a plurality of intersection locations defined by overlapping portions of the pre-impregnated tow to form an intermediate composite open lattice; and (iii) curing the intermediate composite open lattice to provide the composite open lattice.

In another aspect, the present invention provides a system including the following: (i) a mandrel having a plurality of studs extending outwardly from an outer surface of the mandrel, wherein the plurality of studs define a network of pathways; (ii) a first end cap mounted on a first end of the mandrel, in which the first end cap includes a first plurality of guide pins extending radially outward from an outer surface of the first end cap; (iii) a second end cap mounted on a second end of the mandrel, in which the second end cap includes a second plurality of guide pins extending radially outward from an outer surface of the second end cap; and (iv) a feed-system comprising (a) a supply spool, (b) a tension control device, and (c) a tow-laying head located above the mandrel.

In yet another aspect, the present invention provides a composite open lattice. In accordance with certain embodiments of the invention, the composite open lattice may comprise a single continuous polymer-impregnated tow (PIT) of a plurality of structural fibers, the PIT being wound and stacked upon itself to define (i) at least one axial lattice element (ALE), (ii) at least one helical lattice element (HLE), and (iii) a plurality of intersection locations defined by overlapping portions of the PIT.

In yet another aspect, the present invention provides a reinforced shell structure. The reinforced shell structure may comprise (i) a composite open lattice, such as those described and disclosed herein, and (ii) a filament wound shell that overlaps and/or encases at least a portion of the composite open lattice.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 shows a composite open lattice in accordance with certain embodiments of the invention;

FIG. 2 is an exploded view of a portion of the composite open lattice of FIG. 1;

FIG. 3 is a cross-sectional view of the composite open lattice of FIG. 1;

FIG. 4 is a schematic illustrating a cross-sectional view of a portion of a mandrel illustrating central body portions of the studs surrounded by respective raised lips in accordance with certain embodiments of the invention; and

FIG. 5 is a schematic illustrating the deformation of the respective raised lips due to wrapping with a heat activated shrink material prior to and/or during curing in accordance with certain embodiments of the invention

FIG. 6 illustrates a freshly wound mandrel wrapped in a heat activated shrink material prior to curing in accordance with certain embodiments of the invention;

FIG. 7 illustrates the freshly wound mandrel of FIG. 6 with an end cap mounted thereto;

FIG. 8 illustrates a schematic of a system and method of making a composite open lattice in accordance with certain embodiments of the invention;

FIG. 9 shows a pre-impregnated tow of structural fibers being wound through a network of pathways of a mandrel in accordance with certain embodiments of the invention;

FIG. 10 shows a mandrel including a plurality of studs extending outwardly from an outer surface, in which the plurality of studs define a network of pathways, in accordance with certain embodiments of the invention;

FIG. 11 is an isometric view of the mandrel of FIG. 10 and shows a raised lip associated with each of the plurality of studs in accordance with certain embodiments of the invention;

FIG. 12 illustrates a mandrel including a first component comprising an inner mandrel tube and a second component comprising an outer sheath including the plurality of studs;

FIG. 13 illustrates an outside view of an end cap including a plurality of guide pins in accordance with certain embodiments of the invention;

FIG. 14 illustrates an inside view of the end cap of FIG. 13; and

FIG. 15 illustrates a perspective view of the end cap of FIG. 13.

### DETAILED DESCRIPTION

Embodiments of the invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present invention, in accordance with certain embodiments of the invention, relate generally to methods and systems for the formation of composite open lattice from pre-impregnated tow of structural fibers. The composite open lattice may have superior strength-to-weight ratio compared to thin wall composites, especially at the limit of light-weight parts where buckling is the failure mode. Additionally, the composite open lattice may be particularly superior to smooth composites when subjected to cantilever bending loads, since it provides a high Area Moment of Inertia (MOI). As used herein, a “smooth composite” is a composite structure created by building up layers of composite fabrics, each layer substantially filled with fiber (high “cover factor”), and filling the structure with matrix material such that the surface of the resulting structure is uniform and unperforated. As used herein, a “thin wall composite” is a smooth composite structure that has a wall thickness that is small compared to the structure's width or height, such that mechanical deformation is dominated by buckling rather than traditional linear effects. To the contrary, the present invention is directed to an open composite lattice which may be considered to be a truss-like composite structure created by sparsely interlacing composite elements (“elements” may typically be tows of fiber, potentially pre-impregnated with resin), such that the surface of the structure is not closed but contains intentional voids or openings which may have a variety of shapes, such as a rectangular, diamond, hexagonal, or triangular pattern.

In accordance with certain embodiments of the invention, the composite open lattice may be built from a winding process that forms lattice elements including helical lattice elements (HLE) as well as axial lattice elements (ALE). Axial lattice elements are not common in traditional filament winding processes and resulting structures, and the intersections of the HLEs and the ALEs of the open composite lattices are one structural feature that differentiates them from braided structures. Moreover, the lattice elements may be built up in layers from an innermost diameter (e.g., stacked upon itself in successive layers).

Additionally, the composite open lattice may have an accurately defined shape, consistent in each manufactured article, since the winding process guides the outside dimensions of the composite open lattice within a flexible (e.g., silicone) mandrel component in accordance with certain embodiments of the invention and as discussed in greater detail below. In this regard, the interior surface of the composite open lattice may be consistent and circular (e.g., or whatever internal cross-sectional shape may be desired). Additionally or alternatively, the method of making a composite open lattice may be performed without the structural fibers being cut or damaged in the length of the composite open lattice created (e.g., devoid of cut and/or damaged fibers in the length of the composite open lattice), despite the sharp turns during manufacturing (as discussed below in relation to end caps having guide pins). In this regard, the composite open lattice is built layer-by-layer from the bottom (e.g., inner), not cut into an existing solid tube. In accordance with certain embodiments of the invention, the tow-laying head (e.g., a glass tube guide) may provide reliable tow-laying control without rollers or abrasion (e.g., devoid of rollers or abrasion). For example, the individual thin layers of the structural fibers that are stacked upon each other to form or define the lattice elements and intersections may be stacked such that the cross-section of the element is mostly rectangular (e.g., with the possible exception of a top chamfered edge as discussed below). This is possible because flat tows of structural fibers are stacked, and the mandrel defines a plurality of pathways that keep the stacked tows from sliding apart. In accordance with certain embodiments of the invention, the width of the resulting lattice elements may be nearly the same as the natural tow width, at the winding tension. As noted above and discussed in greater detail below, the lattice elements may have a cross-section that has a chamfered top or exterior edge, for example, due to the use of a flexible and/or deformable mandrel (e.g., a flexible or deformable outer sheath) that may be intentionally deformation during the method of manufacturing to impart the chamfered top or exterior edge of the lattice elements.

In accordance with certain embodiments of the invention, the intersections of lattice elements may only be from about 20% to about 30% taller than the lattice element, despite containing twice as much structural material (e.g., carbon from the structural fibers). For example only, an intersection between an ALE formed from four layers and a HLE formed from four layers would be defined by eight layers (e.g., the four ALE layers and the 4 HLE layers). In this regard, the intersection between the ALE and the HLE includes twice the amount of material but has a thickness that is only about 20% to about 30% taller or thicker than the lattice elements. This desirable result and/or structural feature may be realized due to the use of a deformable and/or flexible mandrel (e.g., deformable and/or flexible outer sheath or surface of the mandrel) that allows the intersection to spread and be wider than the natural tow width and the tows may be compressed especially at the intersections by the curing/consolidation process.

In accordance with certain embodiments of the invention, the open composite lattice is formed from a pre-impregnated tow of structural fibers. As such, the resin/fiber fraction may be precisely controlled since the composite open lattice is made with a pre-impregnated tow. For the same reason, high-quality epoxy resins can be used, and the surface does not show excess resin (unlike winding operations using a bath of vinylester or polyester resin).

In accordance with certain embodiments of the invention, the composite open lattice is an open and three-dimensional structure that is particularly strong for its weight compared to, for example, smooth tubes. The composite open lattice, for instance, may be especially useful for applications where a conventional smooth tube is theoretically (linear model) strong enough but it would fail due to buckling. That is, the composite open lattice, in accordance with certain embodiments of the invention, can take the equivalent amount of material in a 0.01″ thin-wall tube and build a strong resilient lattice. Non-limiting applications for composite open lattices according to certain embodiments of the invention include rifle components and other cantilever applications such as bicycle tubes, quadcopter arms, and antenna/radio towers for space-craft to name a few. For instance, the winding pattern (e.g., the number and/or angle of the HLEs) can be adjusted to provide high torsional strength by increasing, for example, the amount of helical carbon (e.g., HLE layers, number of HLEs, etc.) for driveshafts and bicycle frame tubes. Still further, the composite open lattices may be configured or left more open (e.g., a higher percentage of the composite lattice structure defined by a plurality of openings between the lattice elements) to decrease the drag of an object in air or water. Alternately, the composite open lattices may be configured or used to stabilize a thin shell or skin for missile casing and aircraft fuselage or reinforcing pressure vessels. In some cases this reinforced shell structure could be made as a unibody composite by winding a composite open lattice in the form of a tube then covering the entire mandrel, upon which the composite open lattice is located, with a traditional thin ‘filament wind’ shell, before curing. In this regard, for example, certain embodiments of the invention may also provide a reinforced shell structure comprising a composite open lattice, such as those described and disclosed herein, and a filament wound shell that overlaps and/or encases at least a portion of the composite open lattice. The filament wound shell, for instance, may overlap (e.g., directly overlap and/or be located adjacent the composite open lattice) from about 10% to about 100% of an outermost surface and/or an inner most surface of the composite open lattice, such as from at least about any of the following: 10, 20, 30, 40 and 50%, and/or from at most about any of the following: 100, 98, 95, 90, 80, 70, 60, and 50%. In accordance with certain embodiments of the invention, the outermost surface may comprise the aggregate of the outermost surface of the ALEs, HLEs, intersection locations, and an open surface area of the total number of openings defined by the at least one ALE, the at least one HLE, and the plurality of intersecting locations. The innermost surface area may be determined in a similar manner with respect to the aggregate of the innermost surface of the ALEs, HLEs, intersection locations, and an open surface area of the total number of openings defined by the at least one ALE, the at least one HLE, and the plurality of intersecting locations. In accordance with certain embodiments of the invention, the filament wound shell may comprise one or more polymer-impregnated tows (PIT), such as those described and disclosed herein. The filament wound shell, for example, may be wound around the outside of the composite open lattice to form an encasing while the composite open lattice provides the desired level of structural support and/or properties to the reinforced shell structure.

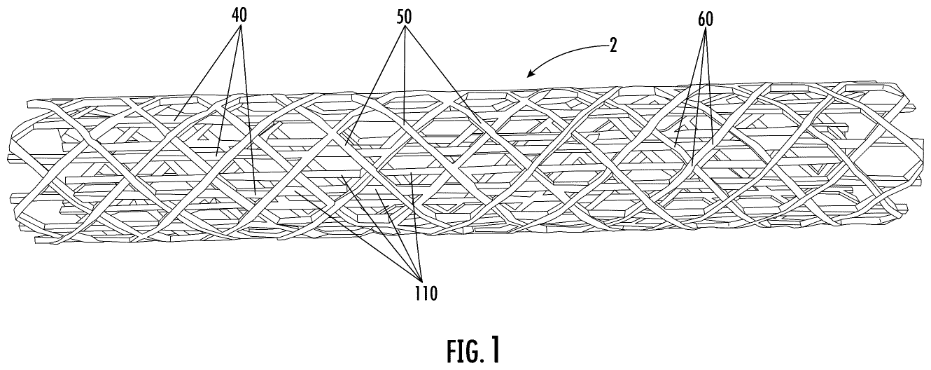

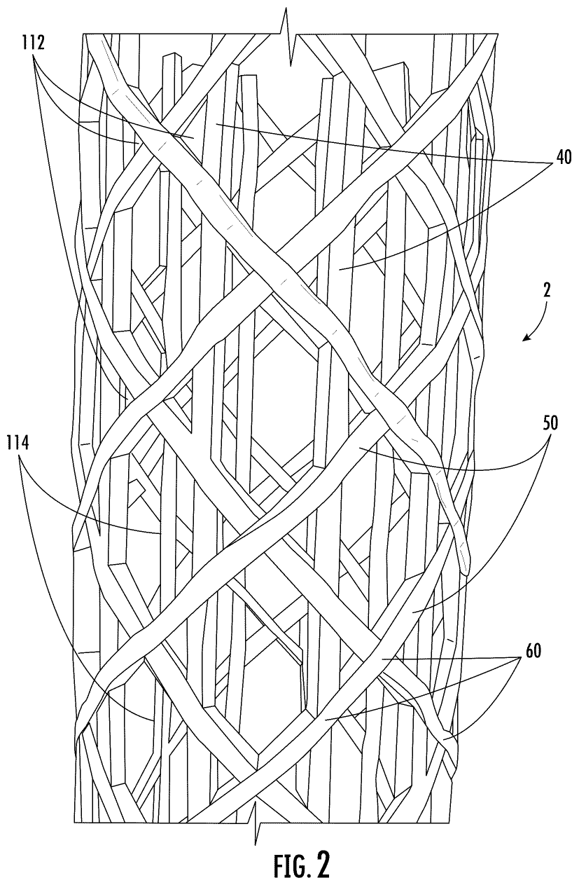

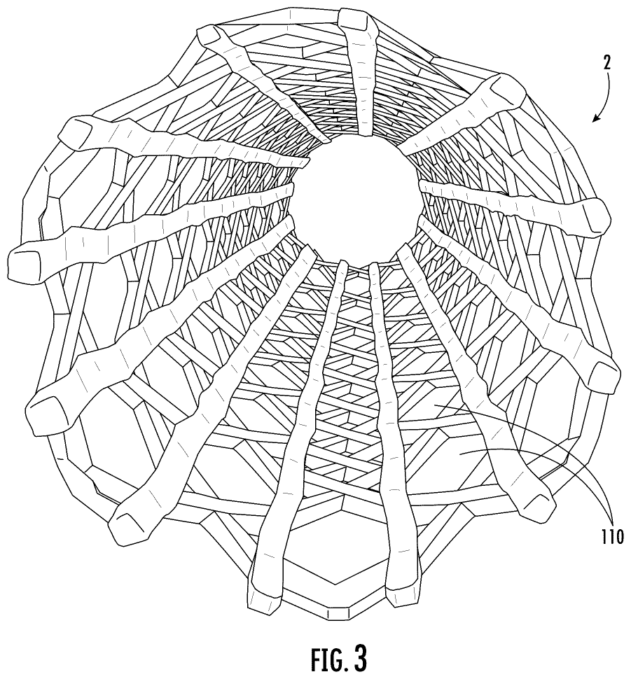

Certain embodiments according to the invention provide a method of making a composite open lattice, in which the method may comprise the following: (i) providing a mandrel having a plurality of studs extending outwardly from an outer surface of the mandrel, wherein the plurality of studs define a network of pathways; (ii) winding a pre-impregnated tow (PIT) of structural fibers through the network of pathways and forming at least one axial lattice element (ALE), at least one helical lattice element (HLE), and a plurality of intersection locations defined by overlapping portions of the PIT to form an intermediate composite open lattice; and (iii) curing the intermediate composite open lattice to provide the composite open lattice. In accordance with certain embodiments of the invention, the PIT of structural fibers may be a single continuous PIT. FIG. 1-3, for instance, illustrate an example composite open structure. FIG. 1 shows a composite open lattice 2 including a plurality of axial lattice elements (ALE) 40, a plurality of helical lattice elements (HLE) 50, a plurality of intersection locations 60 defined by overlapping portions of the ALEs and HLEs, which are each formed from a PIT (e.g., the same PIT). As also shown by FIG. 1, the ALEs, HLEs, and intersection locations define a plurality of openings 110. FIG. 2, for instance, is an exploded view of a portion of the composite open lattice of FIG. 1 and illustrates an example embodiment in which the plurality of openings 110 include a first group of smaller-sized openings 112 and a second group of larger-sized openings 114. FIG. 3 is a cross-sectional view of the composite open lattice of FIG. 1

In accordance with certain embodiments of the invention, the method may comprise forming a plurality of ALEs, such as from 2 to about 30 ALEs, such as at least about any of the following: 2, 4, 6, 8, 10, 12, 14, and 16 ALEs, and/or at most about any of the following: 30, 28, 26, 24, 22, 20, 18, and 15 ALEs. Additionally or alternatively, the method may comprise forming a first plurality of HLEs from a first end of the mandrel to a second end of the mandrel and a second plurality of HLEs from the second end of the mandrel to the first end of the mandrel. In accordance with certain embodiments of the invention, the mandrel may be rotated in a first direction about a longitudinal axis extending from the first end of the mandrel to the second end of the mandrel when forming the first plurality of HLEs and the second plurality of HLEs. The method, in accordance with certain embodiments of the invention, may comprise forming from about 2 to about 30 HLEs, such as at least about any of the following: 2, 4, 6, 8, 10, 12, 14, and 16 HLEs, and/or at most about any of the following: 30, 28, 26, 24, 22, 20, 18, and 15 HLEs. As noted above, the intersection locations may be defined by overlapping portions of the PIT. The intersection locations, for example, may comprise from about 4 to about 30 layers of the PIT stacked upon itself, such as at least about any of the following: 4, 6, 8, and 10 layers, and/or at most about any of the following: 30, 26, 24, 20, 18, 16, 14, 12, and 10 layers.

In accordance with certain embodiments of the invention, the method may utilize a mandrel comprising a first component comprising an inner mandrel tube and a second component comprising an outer sheath including the plurality of studs. For example, the outer sheath may comprise a flexible and/or deformable and/or high coefficient-of-thermal-expansion (CTE) material supported by the inner mandrel tube, which may comprise a rigid material (e.g., more rigid than the outer sheath). By way of example only, the flexible and/or deformable and/or high CTE material may comprise a silicone. The inner mandrel tube, by way of example only, may comprise a metal or metal alloy, such as aluminum. Additionally or alternatively, the plurality of studs may include a central body portion surrounded by a raised lip to define a pocket. For example, each of the plurality of studs may include a respective pocket defined by respective central body portions and raised lips.

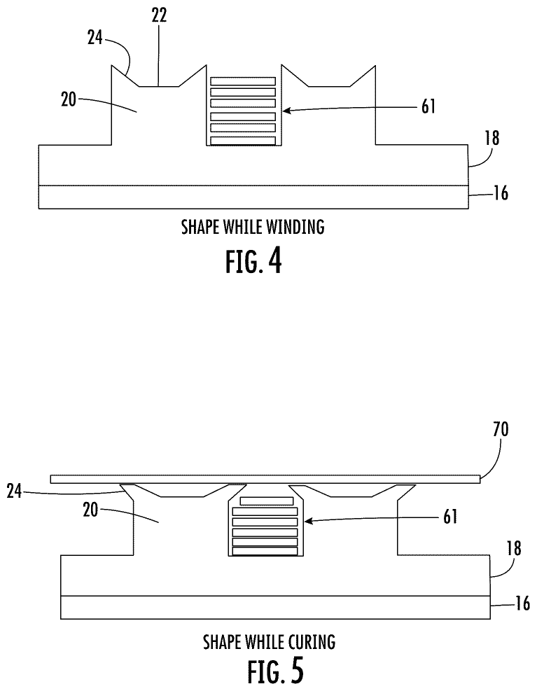

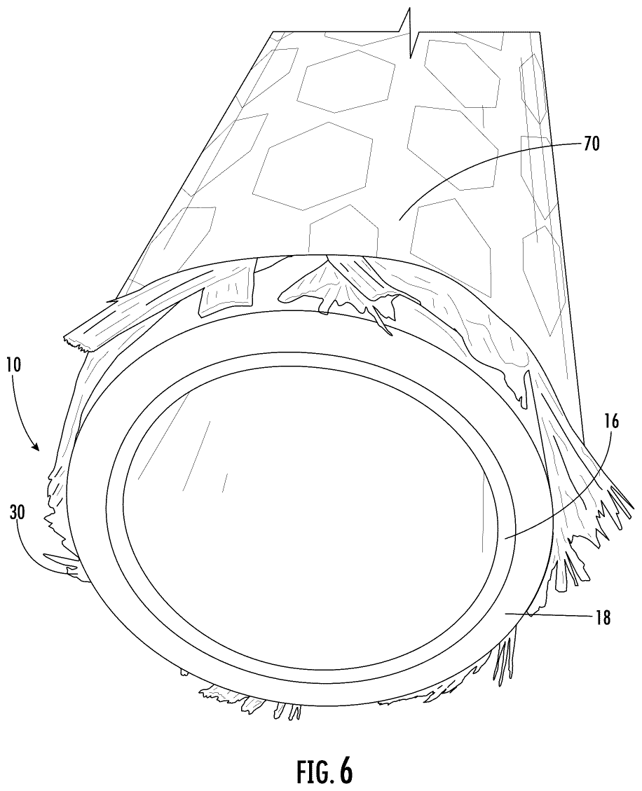

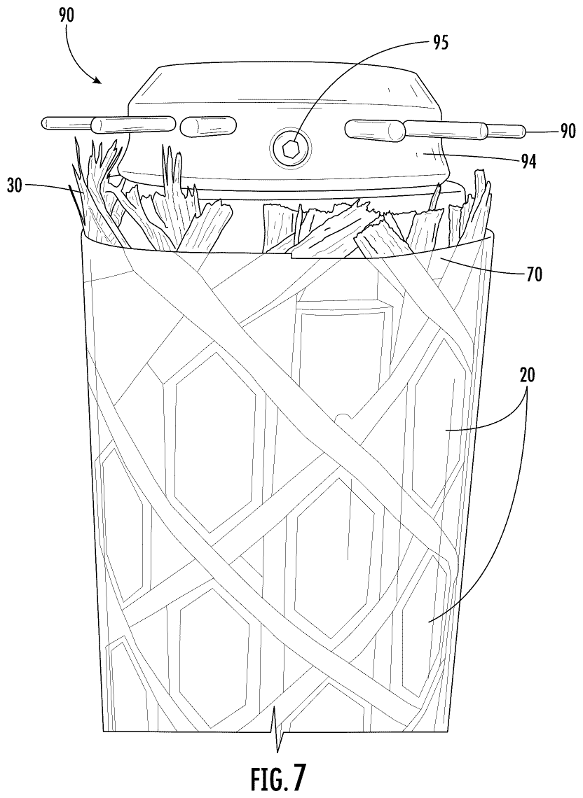

The method, in accordance with certain embodiments of the invention, may comprise wrapping the intermediate composite open lattice with a heat activated shrink material (e.g., a film) prior to curing. In this regard, the method may further comprise deforming the respective raised lips of each of the plurality of studs laterally away from the respective central body portions during wrapping and/or curing of intermediate composite open lattice. In accordance with certain embodiments of the invention, deforming the raised lip of each of the plurality of studs imparts a chamfered top edge (i) on at least a portion of the ALEs, (ii) on at least a portion of the HLEs, (iii) on at least a portion of the plurality of intersection locations, or (iv) and combination of (i) through (iii). FIG. 4, for instance, is a schematic illustrating a cross-sectional view of a portion of a mandrel 10 (including an inner mandrel tube 16 and flexible and/or deformable outer sheath 18) illustrating central body portions 22 of the studs 20 surrounded by respective raised lips 24, in accordance with certain embodiments of the invention, in which a plurality of individual layers 61 at an intersection location 60, or along the length of an ALE 40, or along the length of a HLE 50 are stacked upon each other. FIG. 5 is a schematic illustrating the deformation of the respective raised lips 24 due to wrapping with a heat activated shrink material 70 and/or thermal expansion of the deformable outer sheath 18 prior to and/or during curing in accordance with certain embodiments of the invention. FIG. 6 illustrates a freshly wound mandrel 10 wrapped in a heat activated shrink material 70 prior to curing in accordance with certain embodiments of the invention. FIG. 7 illustrates the freshly wound mandrel of FIG. 6 with an end cap mounted thereto.

In accordance with certain embodiments of the invention, the method may utilize end caps mounted on respective sides of the mandrel. In this regard, the mandrel may include a first end cap mounted on a first end of the mandrel and a second end cap mounted on a second end of the mandrel. The first end cap may include a first plurality of guide pins extending radially outward from an outer surface of the first end cap, and the second end cap may include a second plurality of guide pins extending radially outward from an outer surface of the second end cap. The first plurality of guide pins and the second plurality of guide pins may include the same number of total guide pins and/or be aligned with each other. Additionally or alternatively, the first plurality of guide pins may comprise a plurality of offset pairs of first guide pins and the second plurality of guide pins may comprise a corresponding plurality of offset pairs of second guide pins. In accordance with certain embodiments of the invention, the outer surface of the first end cap from which the first plurality of guide pins extend radially outward has a first diameter that is less than an inside diameter of the inner mandrel tube. Additionally or alternatively, the outer surface of the second end cap from which the second plurality of guide pins extend radially outward has a second diameter that is less than an inside diameter of the inner mandrel tube. For example, the first diameter and the second diameter are the same. In accordance with certain embodiments of the invention, the first end cap and the second end cap are each mounted onto a rotatable drive shaft.

In accordance with certain embodiments of the invention, winding the PIT of structural fibers further comprises wrapping the PIT partially around each of the first plurality of guide pins and the second plurality of guide pins during the step of forming the at least one ALE, the at least one HLE, and the plurality of intersection locations. Each of the first plurality of guide pins and each of the second plurality of guide pins may be individually partially encircled by the PIT of structural fibers (e.g., a single continuous PIT of structural fibers).

In accordance with certain embodiments of the invention, the method may comprise winding the PIT through the network of pathways in successive layers of deposition until a desired thickness defined by an innermost surface of a bottom layer of the PIT stacked upon itself at the intersecting locations and an outermost surface of a top layer of the PIT stacked upon itself at the intersecting locations, wherein the innermost surface defines an internal diameter and the outermost surface defines an outer diameter of the resulting composite open lattice. In accordance with certain embodiments of the invention, for example, the thickness may comprise from about 0.1 cm to about 10 cm, such as at least about any of the following: 0.1, 0.3, 0.5, 0.8, 1, 1.5, 2, 2.5, 3, 4, and 5 cm, and/or at most about any of the following: 10, 9, 8, 7, 6, and 5 cm. Additionally or alternatively, the internal diameter may comprise from about 2 to about 100 cm, such as at least about any of the following: 2, 5, 10, 20, 30, 40 and 50 cm, and/or at most about any of the following: 100, 90, 80, 70, 60, and 50 cm. Additionally or alternatively, the outer diameter may comprise from about 2.1 to about 110 cm, such as at least about any of the following: 2.1, 5, 10, 20, 30, 40 and 50 cm, and/or at most about any of the following: 110, 100, 90, 80, 70, 60, and 50 cm.

As noted above, the method may comprise the formation of a composite open lattice in which (i) the at least one ALE, (ii) the at least one HLE, and (iii) the plurality of intersection locations define a plurality of openings extending through the thickness of the composite open lattice. The respective sizes and/or shapes of the openings may be modified as desired, for example, based on the sizing, geometry, and/or spacing of the plurality of studs that define the network of pathways for forming the respective lattice elements.

In accordance with certain embodiments of the invention, the method may comprise feeding the PIT from a supply under substantially constant tension (e.g., tension does not fluctuate more than about 10%, 5%, 3%, 2%, or 1% of an average or target tension) throughout the duration of the winding step. The PIT, for example, may be pulled from the supply, and passes through a tension control device that pulls the PIT from the supply and controls the release of the PIT to a tow-laying head located above the mandrel. The tension control device, for example, may comprises a pulley system including at least a first stationary positioned pulley and a slideably mounted weighted pulley having a desired weight mounted thereto, in which the slideably mounted weighted pulley traverses a linear path to facilitate constant tension of the PIT even when the PIT wrapping is paused and/or changing direction by being wrapped around a guide pin. The desired weight mounted to the slideably mounted weighted pulley may be altered based on a desired tension on the PIT during the winding step.

In accordance with certain embodiments of the invention, the tow-laying head is mounted on a moveable support structure enabling the tow-laying head to traverse at least an entire length of the mandrel during the winding step. The tow-laying head, by way of example, may comprise a glass tube through which the PIT of structural fibers pass prior to being wound through the network of pathways. The glass tube, for example, may have a rounded and polished discharge edge located proximate to the mandrel.

In accordance with certain embodiments of the invention, the PIT of structural fibers comprise carbon fibers embedded within a polymeric matrix material. The PIT of structural fibers may comprise from about 3,000 to about 50,000 filaments, such as at least about any of the following: 3,000; 5,000; 8,000; 10,000; 12,000; 15,000; 20,000, and 25,000 filaments, and/or at most about any of the following: 50,000; 40,000; 30,000; and 25,000. Additionally or alternatively, the polymeric matrix material (e.g., polymer composition) may comprise a low-tack resin. As used herein, the term “low-tack” comprises a resin with room-temperature viscosity below 2000 centipoise, such as at least about any of the following: 100, 150, 200, 400, and 500 centipoise, and/or at most about any of the following: 2000, 1800, 1500, 1200, 1000, 800, and 500 centipoise. Unlike most PITs for composites that utilize B-staged resin, the polymeric material in accordance with certain embodiments of the invention may comprise an epoxy that cures extremely slowly at room temperature, such as TCR UF3330 from TCR Composites (Utah, USA), that is not sticky so it works with that glass tube of the tow-laying head and the tension is more consistent in the part since it can slide over the mandrel and lower tows due to the tension in the tow. The polymeric material, for instance, may be devoid of a solvent and/or be cured at temperatures, for example, from about 130° ° C. to about 160° C.

In accordance with certain embodiments of the invention, the method may comprise separating the outer sheath and the inner mandrel tube from each other after curing the intermediate composite open lattice. For example, the inner mandrel tube may be pulled out from underneath the outer sheath to leave the composite open lattice housed within the network of pathways of the outer sheath. Subsequently, the method may comprise removing the outer sheath from the composite open lattice.

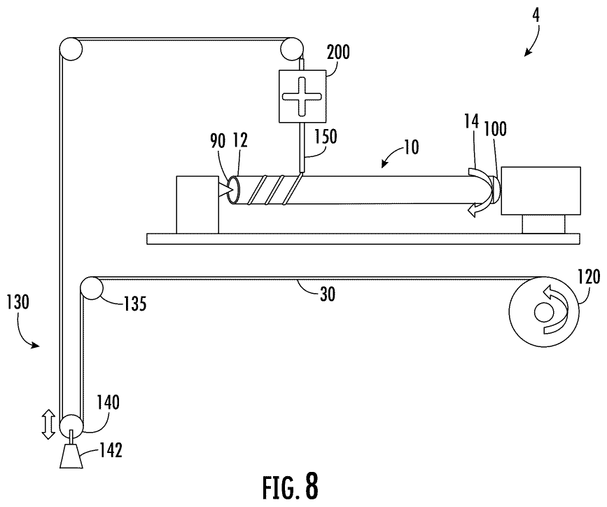

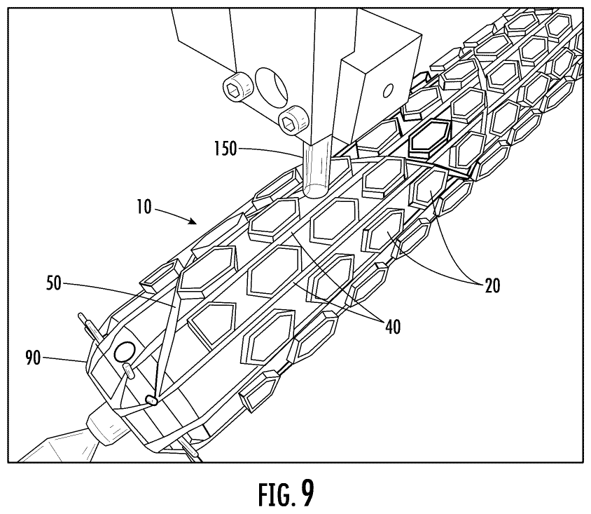

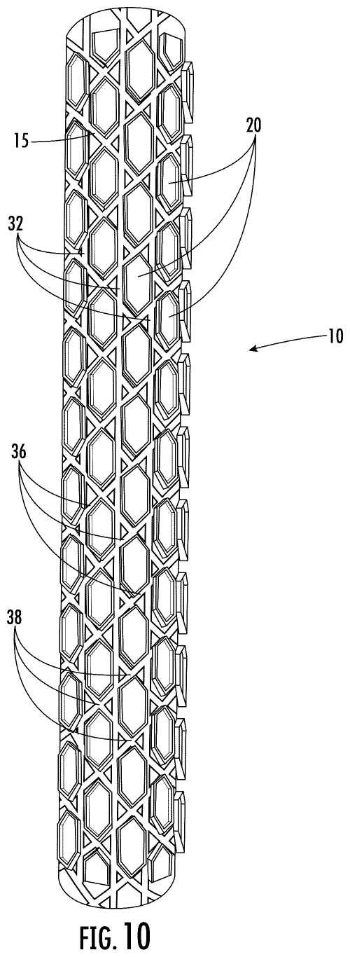

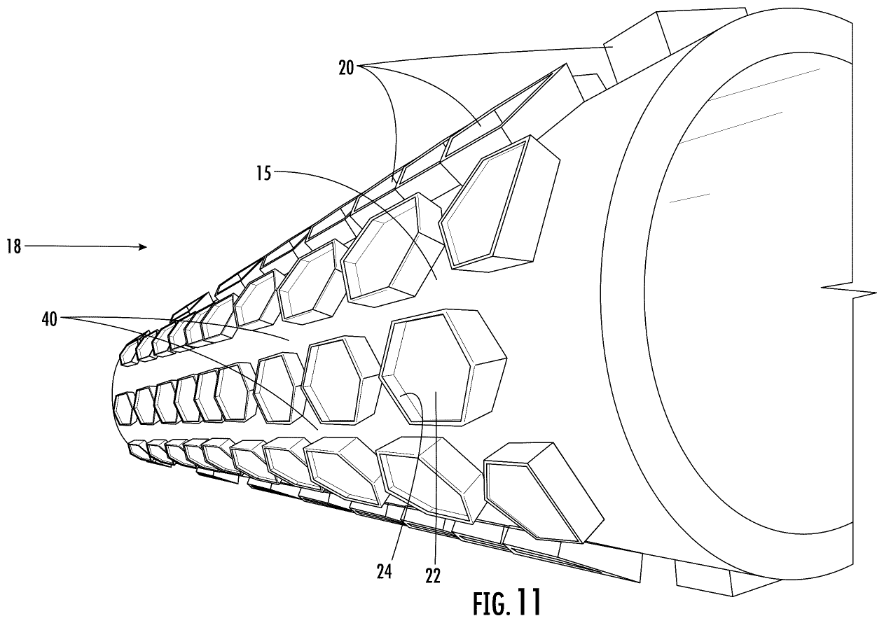

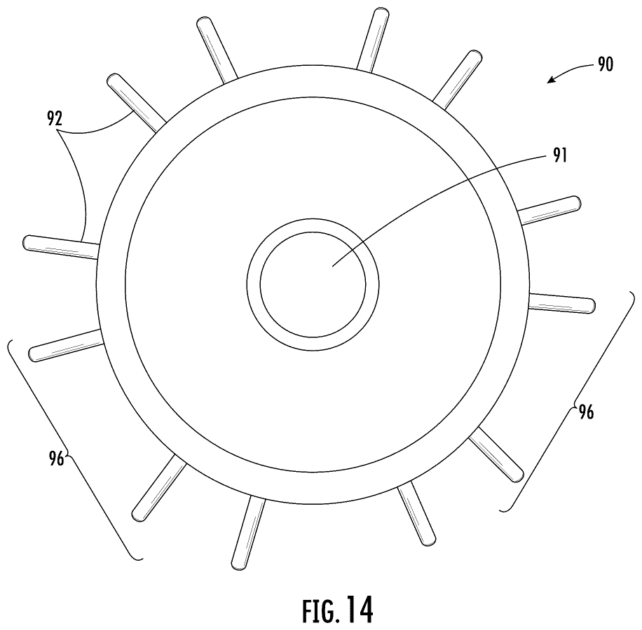

FIG. 8 illustrates a schematic of a system and method of making a composite open lattice in accordance with certain embodiments of the invention. As shown in FIG. 8, the system 4 and method may utilize a mandrel 10 having a plurality of studs 20 (as shown on FIG. 9) extending outwardly from an outer surface of the mandrel, in which the plurality of studs define a network of pathways 15 (as shown on FIG. 10). The system 4 also includes a first end cap 90 mounted on a first end 12 of the mandrel, in which the first end cap includes a first plurality of guide pins 92 (as shown on FIG. 13) extending radially outward from an outer surface 94 (as shown on FIG. 13) of the first end cap. The system may also include a second end cap mounted on a second end of the mandrel, in which the second end cap includes a second plurality of guide pins extending radially outward from an outer surface of the second end cap. The second end cap and associated guide pins may be complementary to those of the first end cap (e.g., mirror images). The system 4 may also include a feed-system comprising (a) a supply spool 120, (b) a tension control device 130, and (c) a tow-laying head 150 located above the mandrel. FIG. 9 shows a PIT of structural fibers 30 (as illustrated on FIG. 8) being wound through a network of pathways 15 of a mandrel 10 in accordance with certain embodiments of the invention. As shown in FIG. 9, the plurality of studs 20 define pathways 15 for the winding of the PIT 30 for the formation of one or more ALE 40, one or more HLE 50, and one or more intersection location 60 (as illustrated in FIGS. 1-2). FIG. 9 illustrates the PIT passing through the tow-laying head 150 and being wound onto the mandrel 10 to fill the network of pathways 15.

In accordance with certain embodiments of the invention, the network of pathways include at least one axial lattice pathway (ALP) extending from the first end of the mandrel to the second end of the mandrel, (ii) at least one helical lattice pathway (HLP) extending from the first end of the mandrel to the second end of the mandrel, and (iii) a plurality of intersection locations defined by intersection of the at least one ALP and the at least one HLP. FIG. 10, for instance, shows a mandrel 10 including a plurality of studs 20 extending outwardly from an outer surface, in which the plurality of studs define a network of pathways 15 including at least one ALP 32, at least one HLP 36, and a plurality of intersection locations 38 defined by the intersection of the at least one ALP and the at least one HLP. FIG. 11 is an isometric view of the mandrel of FIG. 10 and shows a raised lip 24 associated with each of the plurality of studs 20 in accordance with certain embodiments of the invention.

In accordance with certain embodiments of the invention, the at least one ALP may comprise from about 2 to about 30 ALPs, such as at least about any of the following: 2, 4, 6, 8, 10, 12, 14, and 16 ALPs, and/or at most about any of the following: 30, 28, 26, 24, 22, 20, 18, and 15 ALPs. Additionally or alternatively, the at least one HLP may comprise from about 2 to about 30 HLPs, such as at least about any of the following: 2, 4, 6, 8, 10, 12, 14, and 16 HLPs, and/or at most about any of the following: 30, 28, 26, 24, 22, 20, 18, and 15 HLPs.

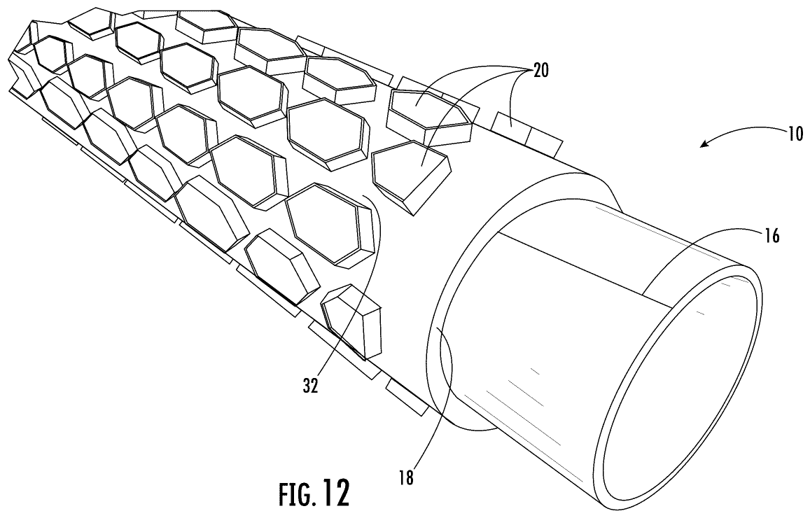

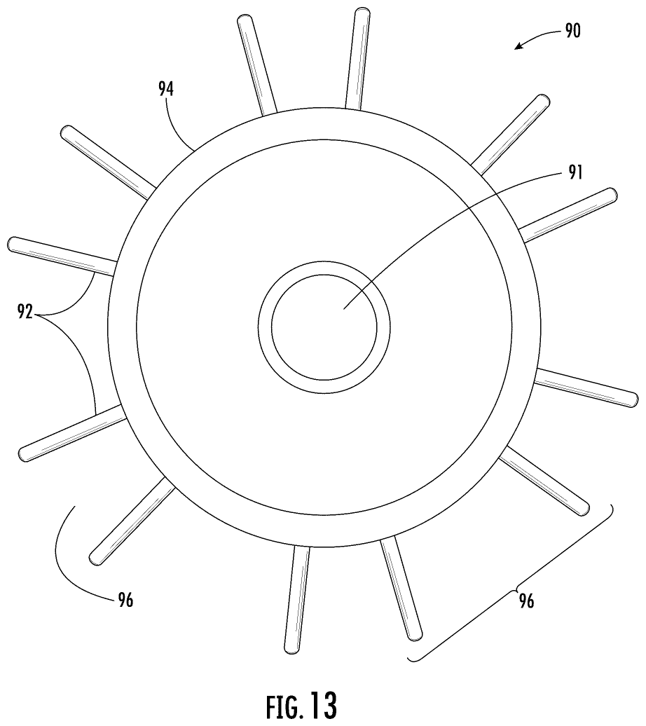

The mandrel 10, in accordance with certain embodiments of the invention, may include a first component comprising an inner mandrel tube 16 and a second component comprising an outer sheath 18 including the plurality of studs 20 as illustrated by FIG. 12. For sake of clear visualization only, the inner mandrel tube 16 is shown in a partially removed or extracted position relative to the outer sheath 18. In this regard, the opposing ends of the inner mandrel tube 16 and the outer sheath may be flush or substantially flush with each other. The outer sheath 18 may comprise a deformable and/or flexible material supported by the inner mandrel tube 18, which may comprise a rigid material (e.g., more rigid relative to the deformable and/or flexible material of the outer sheath). By way of example only, the flexible and/or deformable material may comprise a silicone. The inner mandrel tube, by way of example only, may comprise a metal or metal alloy, such as aluminum. Additionally or alternatively, the plurality of studs 20 may include a central body portion 22 surrounded by a raised lip 24 to define a pocket as illustrated in FIG. 11. For example, each of the plurality of studs 20 may include a respective pocket defined by respective central body portions 22 and raised lips 24. As noted above and illustrated by FIGS. 4-5, the raised lip 24 may be intentional deformed during the curing operation by virtue of a heat shrinkable material.

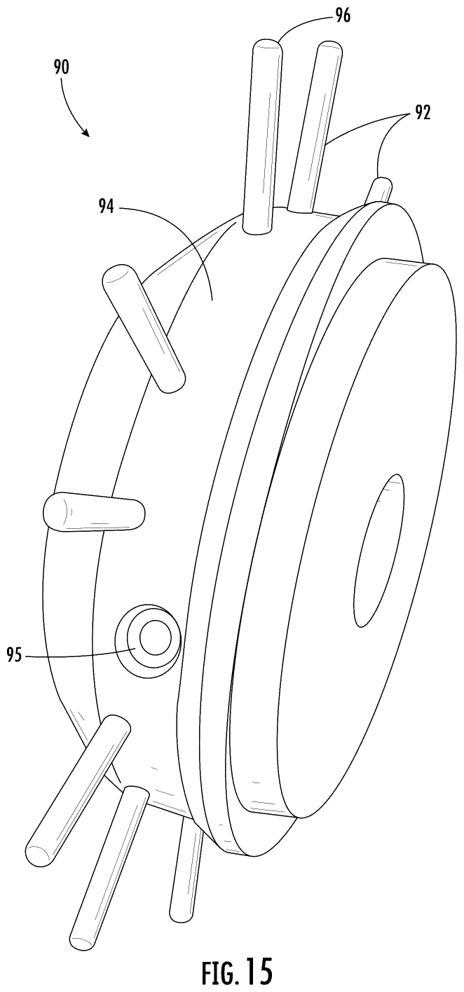

As noted above, each of the end caps include a plurality of guide pins. FIG. 13 illustrates an outside view of the first end cap 90 including a plurality of guide pins 92 extending from an outer surface 94 thereof. The guide pins 92 are positioned, in this particular embodiment, in offset pairs of guide pins 96. The first end cap 90 includes an orifice 91 configured to engage and/or allow a rotatable shaft to extend thereto. FIG. 14 illustrates an inside view of the first end cap 90 of FIG. 13, while FIG. 15 illustrates a perspective view of the first end cap 90 of FIG. 13. As shown in FIG. 15, the first end cap 90 may include a set screw 95 configured to engage a rotatable shaft extending through the orifice 91. In accordance with certain embodiments of the invention, the second end cap has an identical structure but is configured to engage the opposite end of the mandrel. In accordance with certain embodiments of the invention, for instance, the first plurality of guide pins and the second plurality of guide pins are aligned with each other (e.g., mirror images of each other when mounted on opposing ends of the mandrel). For example, the first plurality of guide pins may comprise a plurality of offset pairs of first guide pins and the second plurality of guide pins may comprises a corresponding plurality of offset pairs of second guide pins.

In accordance with certain embodiments of the invention, the outer surface of the first end cap from which the first plurality of guide pins extend radially outward has a first diameter that is less than the outside diameter of the flexible sheath which defines the inner diameter of the composite lattice. Similarly, the outer surface of the second end cap from which the second plurality of guide pins extend radially outward has a second diameter that is less than the outside diameter of the flexible sheath which defines the inner diameter of the composite lattice. In accordance with certain embodiments of the invention, the first diameter of the first end cap and the second diameter of the second end cap, as noted above, may be sized in the manner described above so that the PIT stacking may be more accurate. For example, if the end caps do not have a reduced diameter as noted above, then the stacks of PIT at each guide pin will build up faster than the thickness of the lattice structure, which will cause the PIT to overflow the grooves in the flexible sheath before the desired amount of PIT has been laid into the mandrel. In accordance with certain embodiments of the invention, the first diameter and the second diameter are the same. As noted above, the first end cap and the second end cap may each be mounted onto a rotatable shaft (e.g., drive shaft), wherein the rotatable shaft is driven by a motor operably connected to the rotatable shaft.

In accordance with certain embodiments of the invention, the tow-laying head 150 may be mounted on a moveable support structure 200, such as illustrated in FIG. 8, enabling the tow-laying head to traverse at least an entire length of the mandrel 10. Additionally or alternatively, the tension control device 130 may be configured to allow a PIT 30 to be pulled from the supply spool 120 under substantially constant tension throughout operation of the mandrel 10 and movement of the tow-laying head 150 back-and-forth across the entire length of the mandrel as illustrated in FIG. 1. As noted above, substantially constant tension may mean that the tension on the PIT does not fluctuate more than about 10%, 5%, 3%, 2%, or 1% of an average or target tension throughout the duration of the winding step. The tension control device 130 may comprise a pulley system including at least a first stationary positioned pulley 135 and a slideably mounted weighted pulley 140 having a desired weight 142 mounted thereto. The slideably mounted weighted pulley 140, for example, may traverse a linear path to facilitate constant tension of the PIT 30 even when the PIT wrapping is paused and/or changing direction by being wrapped around a guide pin. The desired weight 142 mounted to the slideably mounted weighted pulley 140 may be altered based on a desired tension on the PIT 30 during the winding step.

The system, in accordance with certain embodiments of the invention, may comprise a control module operatively connected to the motor and the moveable support structure, wherein the control module comprises a computer processor configured to coordinate the rotation of the mandrel and the movement of the moveable support structure for depositing a PIT back-and-forth across the entire length of the mandrel within the network of pathways. For example, the control module may include a control interface operatively connected to the computer processor, wherein the control interface is configured for the input of operating instructions via a user and the computer processor is configured to execute the operating instructions. The control panel may be configured to receive input locally (e.g., at the site of the system with a touch screen or the like), remotely (e.g., via an app on a mobile device), or both.

In yet another aspect and as noted above, the present invention provides a composite open lattice. In accordance with certain embodiments of the invention, the composite open lattice may comprise a single continuous polymer-impregnated tow (PIT) of a plurality of structural fibers, the PIT being wound and stacked upon itself to define (i) at least one axial lattice element (ALE), (ii) at least one helical lattice element (HLE), and (iii) a plurality of intersection locations defined by overlapping portions of the PIT. FIG. 1-3, for instance, illustrate an example composite open structure. FIG. 1 shows a composite open lattice 2 including a plurality of ALEs 40, a plurality of HLEs 50, a plurality of intersection locations 60 defined by overlapping portions of the ALEs and HLEs, which are each formed from a PIT (e.g., the same PIT). As also shown by FIG. 1, the ALEs, HLEs, and intersection locations define a plurality of openings 110. FIG. 2, for instance, is an exploded view of a portion of the composite open lattice of FIG. 1 and illustrates an example embodiment in which the plurality of openings 110 include a first group of smaller-sized openings 112 and a second group of larger-sized openings 114. FIG. 3 is a cross-sectional view of the composite open lattice of FIG. 1. In this regard, each of the lattice elements may be formed from a single continuous PIT, in which the end portions may be cut prior to curing such as shown in FIGS. 6-7.

The PIT includes a cured polymeric material, such as discussed above, defining a matrix, while the plurality of structural fibers are embedded or encapsulated within the matrix defined by the cured polymeric material. In accordance with certain embodiments of the invention, at least a portion of the plurality of intersection locations include at least one axially oriented layer of the PIT. For example, at least about 20% of the plurality of intersection locations include at least one axially oriented layer of the PIT, such as at least about 20, 30, 40, and 50% of the plurality of intersection locations include at least one axially oriented layer of the PIT, and/or at most about 100, 90, 80, 70, 60, and 50% of the plurality of intersection locations include at least one axially oriented layer of the PIT. The composite open lattice, in accordance with certain embodiments of the invention, may comprise from 2 to about 30 ALEs, such as at least about any of the following: 2, 4, 6, 8, 10, 12, 14, and 16 ALEs, and/or at most about any of the following: 30, 28, 26, 24, 22, 20, 18, and 15 ALEs. Additionally or alternatively, the composite open lattice may comprise from 2 to about 30 HLEs, such as at least about any of the following: 2, 4, 6, 8, 10, 12, 14, and 16 HLEs, and/or at most about any of the following: 30, 28, 26, 24, 22, 20, 18, and 15 HLEs. Additionally or alternatively, the plurality of intersection locations defined by overlapping portions of the PIT may comprise from about 4 to about 20 layers of the PIT stacked upon itself, such as at least about any of the following: 4, 6, 8, and 10 layers, and/or at most about any of the following: 20, 18, 16, 14, 12, and 10 layers.

In accordance with certain embodiments of the invention and as noted above, (i) at least a portion of the ALEs, (ii) at least a portion of the HLEs, (iii) at least a portion of the plurality of intersection locations, or (iv) and combination of (i) through (iii) may have a chamfered top edge. For example, from about 20% to about 100% of the ALEs, from about 20% to about 100% of the HLEs, and/or from about 20% to about 100% of the plurality of intersection locations may have a chamfered top edge (e.g., outer edge). In accordance with certain embodiments of the invention, at least a portion of the ALEs, and at least a portion of the HLEs have a substantially rectangular cross-section with the exception of the chamfered top edges. For example, from about 20% to about 100% of the ALEs, and/or from about 20% to about 100% of the HLEs have a substantially rectangular cross-section with the exception of the chamfered top edges.

In accordance with certain embodiments of the invention, the composite open lattice may have a thickness defined by an innermost surface of a bottom layer of the PIT stacked upon itself at the plurality of intersecting locations and an outermost surface of a top layer of the PIT stacked upon itself at the plurality of intersecting locations, and wherein the innermost surface defines an internal diameter and the outermost surface defines an outer diameter. In this regard, the thickness may comprise from about 0.1 cm to about 10 cm, such as at least about any of the following: 0.1, 0.3, 0.5, 0.8, 1, 1.5, 2, 2.5, 3, 4, and 5 cm, and/or at most about any of the following: 10, 9, 8, 7, 6, and 5 cm. Additionally or alternatively, the internal diameter may comprise from about 2 to about 100 cm, such as at least about any of the following: 2, 5, 10, 20, 30, 40 and 50 cm, and/or at most about any of the following: 100, 90, 80, 70, 60, and 50 cm. Additionally or alternatively, the outer diameter may comprise from about 2.1 to about 110 cm, such as at least about any of the following: 2.1, 5, 10, 20, 30, 40 and 50 cm, and/or at most about any of the following: 110, 100, 90, 80, 70, 60, and 50 cm.

In accordance with certain embodiments of the invention and as noted above, the at least one ALE, the at least one HLE, and the plurality of intersection locations define a plurality of openings extending through the thickness of the composite open lattice. The composite open lattice may have, for example, an open surface area defined by the plurality of openings, in which the open surface area comprises from about 50 to about 90% of a total surface area of the composite open lattice, such as at least about 50, 60, 70 and 75%, and/or at most about 90, 85, 80, and 75%.

In accordance with certain embodiments of the invention, the composite open lattice may have an average Fiber Volume Fraction (FVF) from about 40 to about 80%, such as at least about any of the following: 40, 42, 45, 46, 48, 50, 52, 55, 58, and 60%, and/or at most about any of the following: 80, 78, 75, 72, 70, 68, 65, 62, and 60%. In accordance with certain embodiments of the invention, the at least one ALE may have a FVF from about 40 to about 80%, such as at least about any of the following: 40, 42, 45, 46, 48, 50, 52, 55, 58, and 60%, and/or at most about any of the following: 80, 78, 75, 72, 70, 68, 65, 62, and 60%. In accordance with certain embodiments of the invention, the at least one HLE may have a FVF from about 40 to about 80%, such as at least about any of the following: 40, 42, 45, 46, 48, 50, 52, 55, 58, and 60%, and/or at most about any of the following: 80, 78, 75, 72, 70, 68, 65, 62, and 60%. In accordance with certain embodiments of the invention, the plurality of ALE/HLE intersection locations may have a FVF from about 40 to about 80%, such as at least about any of the following: 40, 42, 45, 46, 48, 50, 52, 55, 58, and 60%, and/or at most about any of the following: 80, 78, 75, 72, 70, 68, 65, 62, and 60%. In accordance with certain embodiments of the invention, the plurality of HLE/HLE intersection locations may have a FVF from about 40 to about 80%, such as at least about any of the following: 40, 42, 45, 46, 48, 50, 52, 55, 58, and 60%, and/or at most about any of the following: 80, 78, 75, 72, 70, 68, 65, 62, and 60%. In accordance with certain embodiments of the invention, the average FVF of the plurality of HLE/HLE intersection locations (e.g., 70-75%) may be larger than the average FVF of the plurality of ALE/HLE intersection locations (e.g., 62-68%), while the average FVF of the plurality of ALE/HLE intersection locations may be larger than the average FVF of the at least one ALE (e.g., 52-60%), while the average FVF of the at least one ALE may be larger than the average FVF of the at least one HLE (e.g., 40-50%). In accordance with certain embodiments of the invention, the FVF is determined based by comparing the total cross-sectional area of the element in question with the fiber area based on fiber count and known fiber cross-sectional area. Alternatively, in accordance with certain embodiments of the invention, the FVF is determined via a burn-off test in accordance with ASTM D3171.

In accordance with certain embodiments of the invention, the composite open lattice may have a compressive strength from about 5 to about 15 kN, such as at least about any of the following: 5, 6, 8 and 10 kN, and/or at most about any of the following: 15, 12, and 10 kN. Additionally or alternatively, the composite open lattice may have a bending strength from about 80 to about 150 N*m, such as at least about any of the following: 80, 85, 90, 95, 100, 105, and 110 N*m, and/or at most about any of the following: 150, 140, 130, 120, and 110 N*m. Additionally or alternatively, the composite open lattice may have a mass from about 0.1 to about 0.5 kg/m, such as at least about any of the following: 0.1, 0.15, 0.2, 0.25, and 0.3 kg/m, and/or at most about any of the following: 0.5, 0.45, 0.4, 0.35, and 0.3 kg/m. Additionally or alternatively, the composite open lattice may have a compressive strength (kN) to mass (kg/m) from about 30 to about 80 kN/(kg/m), such as at least about any of the following: 30, 35, 40, 42, 45, 48, and 50 kN/(kg/m), and/or at most about any of the following: 80, 75, 70, 65, 60, 55, and 50 kN/(kg/m). Additionally or alternatively, the composite open lattice may have a bending strength (N*m) to mass (kg/m) from about 550 to about 800 (N*m)/(kg/m), such as at least about any of the following: 550, 575, 600, 620, 640, 660, and 680 kN/(kg/m), and/or at most about any of the following: 800, 775, 750, 725, 700, and 680 kN/(kg/m). The compressive strength is determined in accordance with ASTM D695, while the bending strength is determined in accordance with ASTM D7264.

These and other modifications and variations to embodiments of the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A method of making a composite open lattice, comprising:
(i) providing a mandrel having a plurality of studs extending outwardly from an outer surface of the mandrel, wherein the plurality of studs define a network of pathways;
(ii) winding a pre-impregnated tow (PIT) of structural fibers through the network of pathways and forming at least one axial lattice element (ALE), (ii) at least one helical lattice element (HLE), and (iii) a plurality of intersection locations defined by overlapping portions of the PIT to form an intermediate composite open lattice;
(iii) curing the intermediate composite open lattice to provide the composite open lattice.

2. The method of claim 1, wherein the PIT of structural fibers is a single continuous PIT.

3. The method of claim 1, wherein the method comprises forming a first plurality of HLEs from a first end of the mandrel to a second end of the mandrel and a second plurality of HLEs from the second end of the mandrel to the first end of the mandrel.

4. The method of claim 3, wherein the mandrel is rotated in a first direction about a longitudinal axis extending from the first end of the mandrel to the second end of the mandrel when forming the first plurality of HLEs and the second plurality of HLEs.

5. The method of claim 1, wherein the mandrel comprises a first component comprising an inner mandrel tube and a second component comprising an outer sheath including the plurality of studs.

6. The method of claim 5, wherein the outer sheath comprises a flexible material supported by the inner mandrel tube comprising a rigid material.

7. The method of claim 5, wherein the plurality of studs include a central body portion surrounded by a raised lip to define a pocket.

8. The method of claim 1, further comprising wrapping the intermediate composite open lattice with a heat activated shrink material prior to curing.

9. The method of claim 8, further comprising deforming the raised lip of each of the plurality of studs laterally away from the respective central body portions during wrapping and/or curing of intermediate composite open lattice, and wherein deforming the raised lip of each of the plurality of studs imparts a chamfered top edge (i) on at least a portion of the ALEs, (ii) on at least a portion of the HLEs, (iii) on at least a portion of the plurality of intersection locations, or (iv) and combination of (i) through (iii).

10. The method of claim 1, wherein the mandrel includes a first end cap mounted on a first end of the mandrel and a second end cap mounted on a second end of the mandrel, the first end cap including a first plurality of guide pins extending radially outward from an outer surface of the first end cap, and the second end cap including a second plurality of guide pins extending radially outward from an outer surface of the second end cap, and wherein the first plurality of guide pins and the second plurality of guide pins are aligned with each other.

11. The method of claim 10, wherein the outer surface of the end caps from which the first plurality of guide pins extend radially outward has a first diameter that is less than an inside diameter of the inner mandrel tube.

12. The method of claim 10, wherein winding the PIT of structural fibers further comprises wrapping the PIT partially around each of the first plurality of guide pins and the second plurality of guide pins during the step of forming the at least one ALE, the at least one HLE, and the plurality of intersection locations.

13. The method of claim 1, wherein the composite open lattice has a thickness defined by an innermost surface of a bottom layer of the PIT stacked upon itself at the intersecting locations and an outermost surface of a top layer of the PIT stacked upon itself at the intersecting locations, and wherein the innermost surface defines an internal diameter and the outermost surface defines an outer diameter.

14. The method of claim 1, wherein (i) the at least one ALE, (ii) the at least one HLE, and (iii) the plurality of intersection locations define a plurality of openings extending through the thickness of the composite open lattice.

15. The method of claim 6, further comprising separating the outer sheath and the inner mandrel tube from each other after curing the intermediate composite open lattice, and removing the outer sheath from the composite open lattice.

16. The method of claim 1, further comprising feeding the PIT from a supply under substantially constant tension throughout the duration of the winding step.

17. The method of claim 16, wherein the PIT is pulled from the supply, and passes through a tension control device that pulls the PIT from the supply and controls the release of the PIT to a tow-laying head located above the mandrel.

18. The method of claim 17, wherein the tow-laying head is mounted on a moveable support structure enabling the tow-laying head to traverse at least an entire length of the mandrel during the winding step.

19. The method of claim 17, wherein the tow-laying head comprises a glass tube through which the PIT of structural fibers pass prior to being wound through the network of pathways.

20. The method of claim 1, wherein the PIT of structural fibers comprise carbon fibers.
